(19) United States
(12) Patent Application Publication
(10) Pub. No.: US 2024/0126829 A1
(43) Pub. Date: Apr. 18, 2024

(54) UNSUPERVISED FEATURE SELECTION METHOD BASED ON LATENT SPACE LEARNING AND MANIFOLD CONSTRAINTS

(71) Applicant: ZHEJIANG NORMAL UNIVERSITY, Jinhu (CN)

(72) Inventors: Xinzhong ZHU, Jinhua (CN); Huiying XU, Jinhua (CN); Xiao ZHENG, Jinhua (CN); Chang TANG, Jinhua (CN); Jianmin ZHAO, Jinhua (CN)

(73) Assignee: ZHEJIANG NORMAL UNIVERSITY, Jinhua (CN)

(21) Appl. No.: 18/275,417

(22) PCT Filed: Dec. 7, 2021
(86) PCT No.: PCT/CN2021/135895

§ 371 Date: Aug. 2, 2023

(30) Foreign Application Priority Data
Feb. 3, 2021 (CN) 202110146550.4

(51) Int. Cl. G06F 17/11; G06F 17/16

(52) U.S. Cl. CPC G06F 17/11; G06F 17/16

(57) ABSTRACT

An unsupervised feature selection method based on latent space learning and manifold constraints includes: S11, inputting an original data matrix to obtain a feature selection model; S12, embedding latent space learning into the feature selection model to obtain a feature selection model with the latent space learning; S13, adding a graph Laplacian regularization term into the feature selection model with the latent space learning to obtain an objective function; S14, solving the objective function by adopting an alternative iterative optimization strategy; and S15, sequencing each feature in the original matrix, and selecting the first k features to obtain an optimal feature subset. Feature selection is performed in a learned potential latent space, and the space is robust to noise. The potential latent space is modeled by non-negative matrix decomposition of a similarity matrix, and the matrix decomposition can unambiguously reflect relationships between data instances.

### CROSS REFERENCE TO THE RELATED APPLICATIONS

This application is the national phase entry of International Application No. PCT/CN2021/135895, filed on Dec. 7, 2021, which is based upon and claims priority to Chinese Patent Application No. 202110146550.4, filed on Feb. 3, 2021, the entire contents of which are incorporated herein by reference.

### TECHNICAL FIELD

The present application relates to the technical field of signal processing and data analysis, in particular to an unsupervised feature selection method based on latent space learning and manifold constraints.

### BACKGROUND

With the advent of the information explosion age, a large amount of high dimensional data, such as images, texts, and medical microarrays, are generated. Processing these high dimensional data directly not only significantly increases the computational time and memory burden of algorithms and computer hardware, but also results in poor performance due to presence of irrelevancy, noise and redundant dimensions. The intrinsic dimensionality of high dimensional data is typically small, and only a portion of features may be used to accomplish a task. As an efficient pre-processing of high dimensional data, feature selection aims at achieving dimensionality reduction by removing some irrelevant and redundant features while preserving the intrinsic data structure.

Over the last decades, many feature selection methods have been proposed based on different data priors. According to whether label information of a sample data category is utilized or not, feature selection methods can be generally divided into three categories: supervised feature selection, unsupervised feature selection, and semi-supervised feature selection.

Generally, unsupervised feature selection methods can be summarized into three types, i.e., filter, wrapper, and embedded.

While previous unsupervised methods have achieved good performance, two problems remain. First, real data instances are not only associated with high dimensional features, but are inherently mutually connected, and the mutual connection information is not fully used for feature selection. Second, feature selection is performed in an original data space, and the performance of these methods is typically affected by noise features and samples.

### SUMMARY

The present application aims to overcome defects in the prior art and provides an unsupervised feature selection method based on latent space learning and manifold constraints. To achieve the above objective, the present application adopts the following technical solutions: an unsupervised feature selection method based on latent space learning and manifold constraints, includes:
S1, inputting an original data matrix to obtain a feature selection model;
S2, embedding latent space learning into the feature selection model to obtain a feature selection model with the latent space learning;
S3, adding a graph Laplacian regularization term into the feature selection model with the latent space learning to obtain an objective function;
S4, solving the objective function by adopting an alternative iterative optimization strategy;
S5, sequencing each feature in the original matrix, and selecting the first k features to obtain an optimal feature subset.

Further, the feature selection model with the latent space learning obtained in step S2 is represented as:

$${min}_{W} {‖ XW - V ‖}_{F}^{2} + α {‖ W ‖}_{2 , 1} + β {‖ A - {VV}^{T} ‖}_{F}^{2}$$

$$s . t . V \geq 0$$

wherein, V∈R^{n×c} represents a latent space matrix of n data, and c represents the number of potential factors; X∈R^{n×d} represents the original data matrix, and d represents a data feature dimension; W∈R^{d×c} represents a transform coefficient matrix, and A represents an adjacency matrix; V^{T} represents a transposed matrix of V; F represents a Frobenius norm; α and β represent parameters that balance latent space learning and potential space feature selection.

Further, step S2 specifically includes:
S21, decomposing the adjacency matrix A into a latent space matrix V and a transposed matrix V^{T} of the latent space matrix V through a symmetrical non-negative matrix decomposition model; wherein the product of V and V^{T} in a low dimensional potential space is represented as:

min∥A−VV^{T}∥_{F}²
S22, performing feature matrix transform on data in the latent space matrix V, and modeling the transformed data through a multiple linear regression model, represented as:

$${min}_{W} {‖ XW - V ‖}_{F}^{2}$$

wherein, W∈R^{d×c} represents a transform coefficient matrix;
S23, adding a l_{2,1} norm regularization term to the transform coefficient matrix W, represented as:

$${min}_{W , V} {‖ XW - V ‖}_{F}^{2} + α {‖ W ‖}_{2 , 1}$$

S24, embedding latent space learning into the feature selection model to obtain a feature selection model with the latent space learning.

Further, the objective function obtained in step S3 is represented as:

$$F ( W , V ) = {min}_{W , V} {‖ XW - V ‖}_{F}^{2} + α {‖ W ‖}_{2 , 1} + β {‖ A - {VV}^{T} ‖}_{F}^{2} + γ Tr ( {W}^{T} {X}^{T} LW )$$

$$s . t . V \geq 0$$

wherein, γ represents an equilibrium local manifold geometry regularization coefficient; L represents a Laplacian matrix, L=D−S; D represents a diagonal matrix, Dᵢᵢ=Σⱼ₌₁ⁿS_{if}, S represents a similarity matrix of similarity between pairs of measured data instances, represented as:

$${S}_{ij} = \{ \begin{matrix}exp ( \frac{{‖ {x}_{i} - {x}_{j} ‖}_{F}^{2}}{- 2 σ} ) , & {x}_{i} ∈ {N}_{k} ( {x}_{j} ) or {x}_{j} ∈ {N}_{k} ( {x}_{i} ) \\ 0 , & otherwise\end{matrix}$$

wherein, Nₖ(xᵢ) represents a set of xᵢ nearest neighbors; σ represents a width parameter; xᵢ∈R^{d} represents each row in the original data matrix X∈R^{n×d} sample; xⱼ represents each column in the original data matrix X∈R^{n×d} sample.

Further, step S4 specifically includes:
S41, initializing a latent space matrix V, V=rand(n,c), wherein, rand( ) represents a random function, the number of iterations t=0, t₁=0, Λ^{t}^{₁}=I;
S42, fixing the latent space matrix V, and updating the transform coefficient matrix W, represented as:

\hat{W}=(X^{T}X+αΛ+γX^{T}LX)⁻¹X^{T}V

wherein, Λ∈R^{n×n} represents a diagonal matrix;
S43, setting the number of iterations to be t₁=t₁1;
S44, fixing the transform coefficient matrix W, and updating the latent space matrix V, represented as:

$${V}_{ij} ← {V}_{ij} \frac{{( 2 XW + 4 β AV )}_{ij}}{{( 2 V + 4 β {VV}^{T} V )}_{ij}}$$

wherein, ← represents allocation; Vᵢⱼ represents the i^{th}-row j^{th}-column element in the matrix V;
S45, setting the number of iterations to be t=t+1;
S46, repeatedly executing steps S42-S45 until the objective function converges.

Further, in step S42, the latent space matrix V is fixed, and the objective function is represented as:

$$F ( W ) = {min}_{W} {‖ XW - V ‖}_{F}^{2} + α {‖ W ‖}_{2 , 1} + γ Tr ( {W}^{T} {X}^{T} LXW )$$

the diagonal matrix Λ is introduced into the objective function, and the diagonal matrix Λ is represented as:

$$Λ ( i , i ) = \frac{1}{2 {‖ W ( i , : ) ‖}_{2}}$$

wherein, ∥W(i,:)∥₂ represents the 2 norm of the i^{th} row vector, i.e. the feature quantity;
the objective function F(W) is translated into a weighted least squares problem, represented as:

$$F ( \hat{W} ) = {min}_{W} {‖ XW - V ‖}_{F}^{2} + α T r ( {W}^{T} Λ W ) + γ Tr ( {W}^{T} {X}^{T} L X W )$$

a derivative of F(Ŵ) with respect to w is calculated and a calculated derivative result is set to be 0, represented as:

X^{T}(XW−V)+αΛW+γX^{T}LXW=0.

Further, in step S44, the transform coefficient matrix W is fixed, and the objective function is represented as:

$$F ( V ) = {min}_{V} {‖ XW - V ‖}_{F}^{2} + β {‖ A - {VV}^{T} ‖}_{F}^{2} , s . t . V \geq 0$$

a Lagrange multiplier method is used for solving the objective function F(V), in order to limit V≥0, a Lagrange multiplier Θ∈R^{n×x} is set, and a Lagrange function is constructed and represented as:

$$F ( \hat{V} ) = {min}_{V} {‖ XW - V ‖}_{F}^{2} + β {‖ A - {VV}^{T} ‖}_{F}^{2} + Tr ( Θ {V}^{T} )$$

a derivative of F(\hat{V}) with respect to V is calculated and a calculated derivative result is set to be 0, represented as:

−2XW+2V−4βAV+4βVV^{T}V+Θ=0.

Compared with the prior art, the present application provides an unsupervised feature selection method based on latent space learning and manifold constraints (LRLMR). Compared with other unsupervised feature selection algorithms, such as: LS, Baseline, RSR, and DSRMR, the LRLMR method performs feature selection in a learned potential latent space which is robust to noise; the potential latent space is modeled by a non-negative matrix decomposition of a similarity matrix, and the matrix decomposition can unambiguously reflect relationships between data instances. Meanwhile, the local manifold structure of the original data space is preserved by graph-based manifold constraints in the potential latent space. Moreover, an effective iterative algorithm is developed to optimize the LRLMR objective function, and meanwhile, convergence of the LRLMR method is theoretically analyzed and proved.

### BRIEF DESCRIPTION OF THE DRAWINGS

FIG. 1 is a flow chart of an unsupervised feature selection method based on latent space learning and manifold constraints provided by embodiment I;

FIG. 2 is a schematic diagram of statistics of eight databases provided by embodiment II;

FIG. 3 is a schematic diagram of clustering results (ACC %±std %) of different feature selection methods on each database provided by embodiment II;

FIG. 4 is a schematic diagram of clustering results (NMI %±std %) of different feature selection methods on each database provided by embodiment II;

FIGS. 5A-5H are schematic diagrams of ACC values with different methods corresponding to different numbers of selected features in different data sets provided by embodiment II;

FIGS. 6A-6H are schematic diagrams of NMI values with different methods corresponding to different numbers of selected features in different data sets provided by embodiment II;

FIGS. 7A-7H are schematic diagrams of ACC values with parameters α=1, β=1 kept and with a value of γ changed in an LRLMR method provided by embodiment II;

FIGS. 8A-8H are schematic diagrams of NMI values with parameters α=1, β=1 kept and with a value of γ changed in an LRLMR method provided by embodiment II;

FIGS. 9A-9H are schematic diagrams of ACC values with parameters α=1, γ=1 kept and with a value of β changed in an LRLMR method provided by embodiment II;

FIGS. 10A-10H are schematic diagrams of NMI values with parameters α=1, γ=1 kept and with a value of β changed in an LRLMR method provided by embodiment II;

FIGS. 11A-11H are schematic diagrams of ACC values with parameters β=1, γ=1 kept and with a value of α changed in an LRLMR method provided by embodiment II;

FIGS. 12A-12H are schematic diagrams of NMI values with parameters β=1, γ=1 kept and with a value of α changed in an LRLMR method provided by embodiment II; and

FIGS. 13A-13H are schematic diagrams of convergence curves of algorithm I in different data sets provided by embodiment II.

### DETAILED DESCRIPTION OF THE EMBODIMENTS

The embodiments of the present application are illustrated below through specific examples, and other advantages and effects of the present application can be easily understood by those skilled in the art based on the contents disclosed herein. The present application can also be implemented or applied through other different specific embodiments. Various modifications or changes to the details described in the specification can be made based on different perspectives and applications without departing from the spirit of the present application. It should be noted that, unless conflicting, the embodiments and features of the embodiments may be combined with each other.

Aiming at the existing defects, the present application provides an unsupervised feature selection method based on latent space learning and manifold constraints.

### Embodiment I

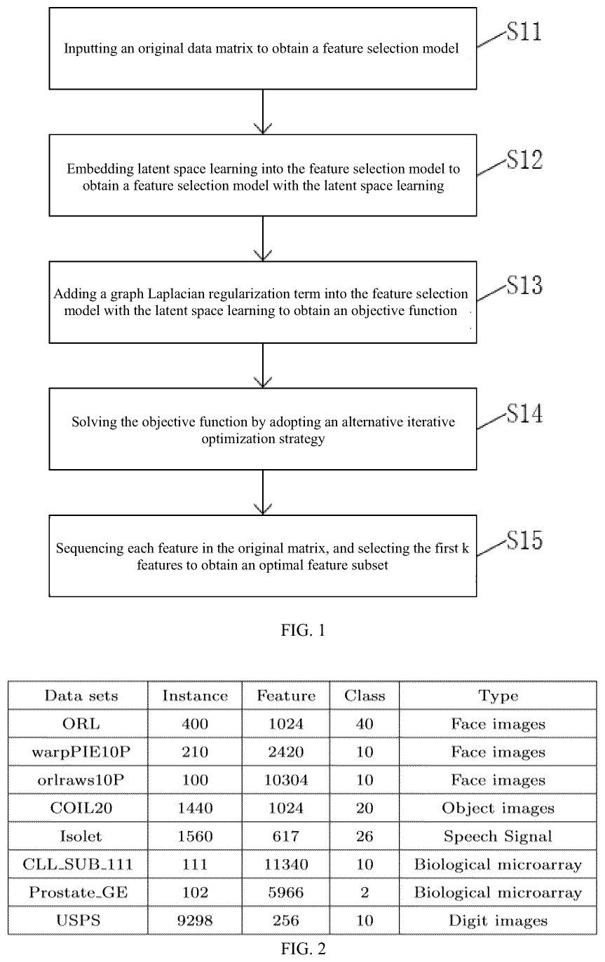

The unsupervised feature selection method based on latent space learning and manifold constraints provided by this embodiment, as shown in FIG. 1, includes:
S11, inputting an original data matrix to obtain a feature selection model;
S12, embedding latent space learning into the feature selection model to obtain a feature selection model with the latent space learning;
S13, adding a graph Laplacian regularization term into the feature selection model with the latent space learning to obtain an objective function;
S14, solving the objective function by adopting an alternative iterative optimization strategy;
S15, sequencing each feature in the original matrix, and selecting the first k features to obtain an optimal feature subset.

This embodiment provides a feature selection method based on potential latent space learning and graph-based manifold constraints (LRLMR). In particular, a traditional similarity graph is constructed to represent mutual connection of data samples. Potential latent space learning is embedded into a framework to reduce negative impacts of noise connection in a similarity graph. Meanwhile, feature latent space is modeled in a learned potential space, which can not only represent an intrinsic data structure but also serve as label information to guide a feature selection stage. In addition, the similarity graph is also used to preserve a local manifold structure of original data in a feature transform space.

In step S11, an original data matrix is inputted to obtain a feature selection model.

The original data matrix X∈R^{n×d} is inputted, and each row xᵢ∈R^{d} is a sample.

In step S12, latent space learning is embedded into the feature selection model, and a feature selection model with the latent space learning is obtained. The step specifically includes:
S121, decomposing an adjacency matrix A into a latent space matrix V and a transposed matrix V^{T} of a latent space matrix V through a symmetrical non-negative matrix decomposition model;
potential latent spaces of different examples are interacted and link information is formed, a potential latent space of the link information can be formed by a symmetrical non-negative matrix decomposition model, and the model decomposes the adjacency matrix A into a non-negative matrix V and its transposed matrix V^{T}; the product of V and V^{T} in a low dimensional potential space is represented as:

min∥A−VV^{T}∥_{F}².
S122, performing feature matrix transform on data in the latent space matrix V, and modeling the transformed data through a multiple linear regression model;
impacts of noise can be avoided by performing feature selection in a potential latent space, and meanwhile, the data transformed by the feature transform matrix is beneficial to learning of the latent space. In addition, potential factors encode some latent properties of examples, which should be related to some features of a data instance. Therefore, the content information of the data is modeled by a multiple linear regression model with the potential latent space matrix V as a constraint, represented as:

$${min}_{W} {‖ XW - V ‖}_{F}^{2}$$

wherein, W∈R^{d×c} represents the transform coefficient matrix.
S123, adding a l_{2,1} norm regularization term to the transform coefficient matrix W;
W∈R^{d×c} is the transform coefficient matrix, and the 2 norm ∥W(i,:)∥₂ of the i^{th} row vector can be used as a feature quantity due to reflecting importance of an i^{th} feature in the latent space. To regularize the coefficient matrix, an expression of row sparsity is desired. To achieve this target, for joint sparsity of all potential factors, a l_{2,1} norm regularization term is added above, represented as:

$${min}_{W , V} {‖ XW - V ‖}_{F}^{2} + α {‖ W ‖}_{2 , 1}$$

wherein, α controls sparsity of the model.
S124, embedding latent space learning into the feature selection model to obtain a feature selection model with the latent space learning, represented as:

$${min}_{W} {‖ XW - V ‖}_{F}^{2} + α {‖ W ‖}_{2 , 1} + β {‖ A - {VV}^{T} ‖}_{F}^{2}$$

$$s . t . V \geq 0$$

wherein, V∈R^{n×c} represents a latent space matrix of n data, and c represents the number of potential factors; X∈R^{n×d} represents the original data matrix, and d represents a data feature dimension; W∈R^{d×c} represents a transform coefficient matrix, and A represents an adjacency matrix; V^{T} represents a transposed matrix of V; F represents a Frobenius norm; α and β represent parameters that balance latent space learning and potential space feature selection.

In step S13, a graph Laplacian regularization term is added into the feature selection model with the latent space learning to obtain an objective function.

A local manifold geometry structure of the original data is preserved in the potential space, and therefore the graph Laplacian regularization term is added into the model to obtain a final objective function, represented as:

$$F ( W , V ) = {min}_{W , V} {‖ XW - V ‖}_{F}^{2} + α {‖ W ‖}_{2 , 1} + β {‖ A - {VV}^{T} ‖}_{F}^{2} + γ Tr ( {W}^{T} {X}^{T} L W )$$

$$s . t . V \geq 0$$

wherein, γ represents an equilibrium local manifold geometry regularization coefficient; L represents a Laplacian matrix, L=D−S; D represents a diagonal matrix, Dᵢᵢ=Σⱼ₌₁ⁿSᵢⱼ, S represents a similarity matrix of similarity between pairs of measured data instances, represented as:

$${S}_{ij} = \{ \begin{matrix}exp ( \frac{{‖ {x}_{i} - {x}_{j} ‖}_{F}^{2}}{- 2 {σ}^{2}} ) , {x}_{i} ∈ {N}_{k} ( {x}_{j} ) or {x}_{j} ∈ {N}_{k} ( {x}_{i} ) \\ 0 , otherwise\end{matrix}$$

wherein, Nₖ(xᵢ) represents a set of xᵢ nearest neighbors; σ represents a width parameter; xᵢ∈R^{d} represents each row in the original data matrix X∈R^{n×d} sample; xⱼ represents each column in the original data matrix X∈R^{n×d} sample. The adjacency matrix A is obtained using the exponential function described above, and the only difference is that A is fully connected but S is sparse.

The transform coefficient matrix W and the potential latent space matrix V can be obtained by minimizing the objective function F(W,V), and it is to be seen from the function that when W is fixed, the potential latent space learning stage is not only related to the adjacency matrix A, but also related to the data matrix X In this case, the learned potential latent space can capture the inherent link between data instances and is more robust to similarity noise in an initial adjacency matrix. When the potential latent space matrix V is fixed, V can be considered as label information to guide feature selection.

In step S14, the objective function is solved by adopting an alternative iterative optimization strategy. The step specifically includes:
S141, initializing a latent space matrix V, V=rand (n,c), wherein, rand( ) represents a random function, the number of iterations t=0, t₁=0, Λ^{t}^{₁}=I;
S142, fixing the latent space matrix V, and updating the transform coefficient matrix;
when V is fixed, the objective function is convex, represented as:

$$F ( W ) = {min}_{W} {‖ XW - V ‖}_{F}^{2} + α {‖ W ‖}_{2 , 1} + γ Tr ( {W}^{T} {X}^{T} L X W )$$

The above formula can be solved by iterative re-weighted least squares (IRLS). For the IRLS, a diagonal matrix Λ∈R^{n×n} needs to be introduced, whose i th diagonal element is represented as:

$$Λ ( i , i ) = \frac{1}{2 {‖ W ( i , : ) ‖}_{2}}$$

Then, F(W) can be translated into a weighted least squares problem, represented as:

$$F ( \hat{W} ) = {min}_{W} {‖ XW - V ‖}_{F}^{2} + α T r ( {W}^{T} Λ W ) + γ Tr ( {W}^{T} {X}^{T} L X W )$$

A derivative of F(Ŵ) with respect to W is calculated and is set to be 0, represented as:

X^{T}(XW−V)+αΛW+γX^{T}LXW=0.

A closed solution of W is solved, represented as:

\hat{W}=(X^{T}X+αΛ+γX^{T}LX)⁻¹X^{T}V
S143, setting the number of iterations to be t₁=t₁+1;
S144, fixing the transform coefficient matrix W, and updating the latent space matrix;
when W is fixed, the objective function becomes:

$$F ( V ) = {min}_{V} {‖ XW - V ‖}_{F}^{2} + β {‖ A - {VV}^{T} ‖}_{F}^{2} , s . t . V \geq 0$$

A Lagrange multiplier method is used for solving the above function, in order to limit V≥0, a Lagrange multiplier Θ∈R^{n×c} is set, and a Lagrange function is constructed:

$$F ( \hat{V} ) = {min}_{V} {‖ XW - V ‖}_{F}^{2} + β {‖ A - {VV}^{T} ‖}_{F}^{2} + Tr ( Θ {V}^{T} )$$

The derivative of F(\hat{V}) with respect to V is solved and the result is set to be 0:

−2XW+2V−4βAV+4βVV^{T}V+Θ=0

According to Kuhn-Tucker conditions, ΘᵢⱼVᵢⱼ=0, represented as:

$${V}_{ij} ← {V}_{ij} \frac{{( 2 X W + 4 β A V )}_{ij}}{{( 2 V + 4 β {VV}^{T} V )}_{ij}}$$

wherein, ← represents allocation; Vᵢⱼ represents the i^{th}-row j^{th}-column element in the matrix V;
S145, setting the number of iterations to be t=t+1;
S146, repeatedly executing the steps S142-S145 until the objective function converges.

In step S15, each feature in the original matrix is sequenced, and the first k features are selected to obtain an optimal feature subset.

According to ∥W(i,:)∥₂, (i=1,2, . . . , d) each feature of X is sequenced in a descending order and the first k features are selected to form an optimal feature subset.

Compared with the prior art, the embodiment provides an unsupervised feature selection method based on latent space learning and manifold constraints (LRLMR). Compared with other unsupervised feature selection algorithms, such as: LS, Baseline, RSR, and DSRMR, the LRLMR method performs feature selection in a learned potential latent space which is robust to noise; the potential latent space is modeled by a non-negative matrix decomposition of the similarity matrix, and the matrix decomposition can unambiguously reflect the relationships between data instances. Meanwhile, the local manifold structure of the original data space is preserved by graph-based manifold constraints in the potential latent space. Moreover, an effective iterative algorithm is developed to optimize the LRLMR objective function, and meanwhile, convergence of the LRLMR method is theoretically analyzed and proved.

### Embodiment II

The unsupervised feature selection method based on latent space learning and manifold constraints provided by this embodiment is different from embodiment I in that:
this embodiment is to fully verify validity of the LRLMR method of the present application.

The performance of the LRLMR method is tested on eight commonly used basic databases (ORL, warpPIE10P, orlraws10P, COIL20, Isolet, CLL_SUB_111, Prostate_GE, USPS), meanwhile, comparison is performed with the following nine currently popular unsupervised feature selection algorithms:
(1) Baseline: all original features being used.
(2) LS: Laplacian score feature selection, the method selecting a feature most consistent with a Laplacian matrix.
(3) MCFS: multiple clustering feature selection, the method using a norm to normalize a feature selection process into a spectral information regression problem.
(4) RSR: regularized self-representative feature selection, the method using a norm to compute a fitting error and facilitate sparsity.
(5) MFFS: matrix decomposition feature selection, a new unsupervised feature selection criterion developed from a subspace learning perspective, the method translating feature selection into a matrix decomposition problem.
(6) GLoSS: unsupervised feature selection with global and local structures keeping sparse subspace learning models, thereby realizing feature selection and subspace learning simultaneously.
(7) GSR_SFS: graph self-representative sparse feature selection, adopting a traditional fixed similarity graph to preserve the local geometry of the data.
(8) UFS: unsupervised feature selection by norm regularization graph learning, using a norm instead of a traditional norm to measure sample similarity in a selected feature space.
(9) DSRMR: robust unsupervised feature selection of double self-representative and multiple regularization, using a feature self-representative term for feature reconstruction, and meanwhile, using a sample self-representative term to learn a similarity graph with local geometry preserved. In experiments, the LRLMR method is compared with the other nine unsupervised feature selection methods on eight public databases. The eight databases include three face image databases (ORL, orlraws10P, and warpPIE10P), one object image database (COIL20), one speech signal database (Isolet), two biological microarray databases (CLL_SUB_111 and Prostate_GE), and one digit image database (USPS). The statistics of these databases are shown in FIG. 2.

Similar to previous unsupervised feature selection methods, K-means clustering is performed using selected features, and two widely applied evaluation criteria, namely clustering accuracy (ACC) and normalized mutual information (NMI), are adopted. The greater ACC and NMI values are, the better the method performance is. Assuming qᵢ is a clustering result and pi is a real label, then ACC is defined as:

$$ACC = \frac{{\sum }_{i = 1}^{n} δ ( {p}_{i} , map ( {q}_{i} ) )}{n}$$

wherein, if x=Y , δ(x, y)=1, otherwise δ(x, y)=0. map(qᵢ) is a best mapping function, and the function of the mapping function is to match a clustering label obtained by an experiment with a real label of a sample through a Kuhn-Munkres algorithm.

Two variables P and Q are given, and NMI is defined as:

$$NMI ( P , Q ) = \frac{I ( P , Q )}{\sqrt{H ( P ) H ( Q )}}$$

wherein H (P) and H(Q) represent entropy of P and Q respectively, and I(P, Q) represents mutual information between P and Q respectively. P is a clustering result of input samples, and Q are their real labels. NMI reflects consistency between a clustering result and a real label.

In experiments, parameters of the LRLMR algorithm and other comparison methods are set, and the size k=5 of neighbor parameters of all databases is set for LS, GLoSS, MCFS, GSR_SFS and LRLMR of the scheme. For LRLMR, GLoSS, and GSR_SFS, a Gaussian kernel width of a distance function is set to be 1. To make a fair comparison of different methods, remaining parameters of all methods are adjusted from {10⁻³, 10⁻², 10⁻¹, 1, 10, 10⁻², 10⁻³} using a “grid search” strategy. Since an optimal number of selected features is unknown, the number of different selected features is set from {20, 30, . . . , 90, 100} using a “grid search” strategy for all databases. After different feature selection algorithms complete feature selection, a K-means algorithm is adopted to cluster the selected low dimensional features. Considering that performance of K-means clustering may be affected by initialization, 20 different random initialization experiments are repeated and their average values are finally recorded.

### Analysis of Results:

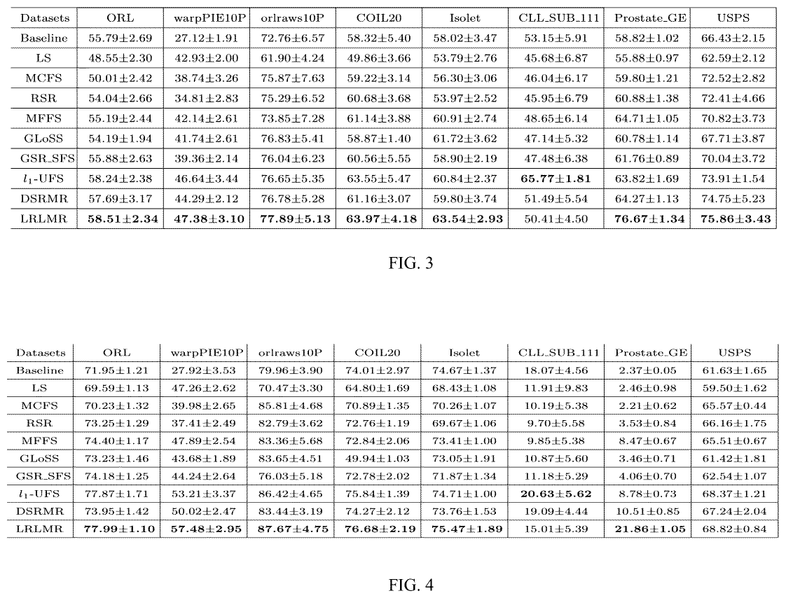

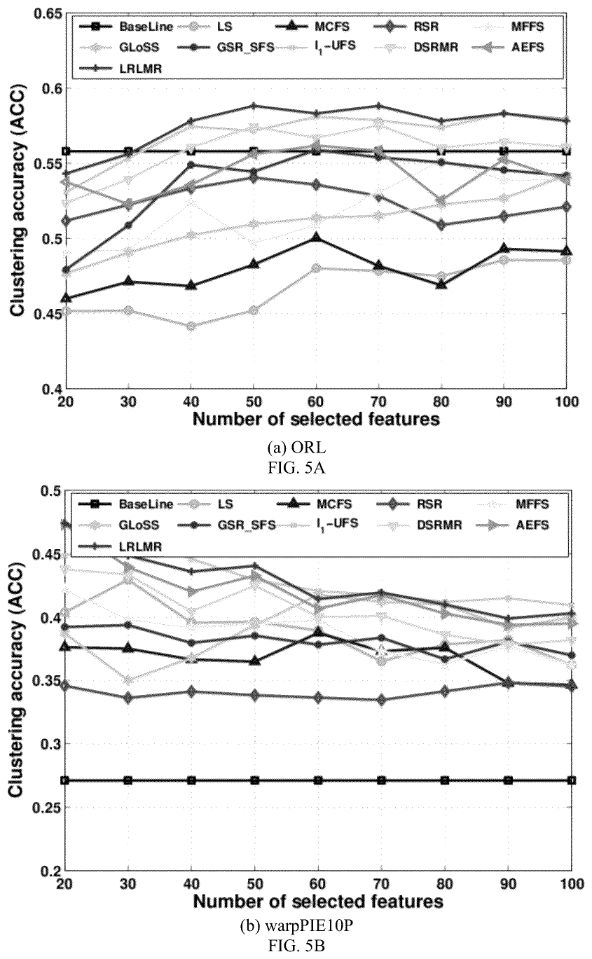

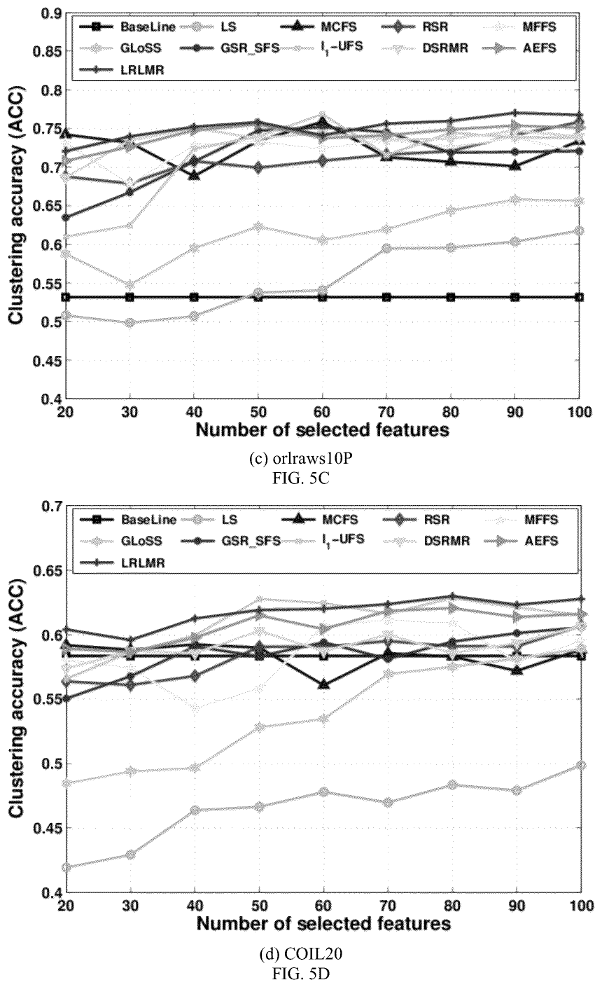

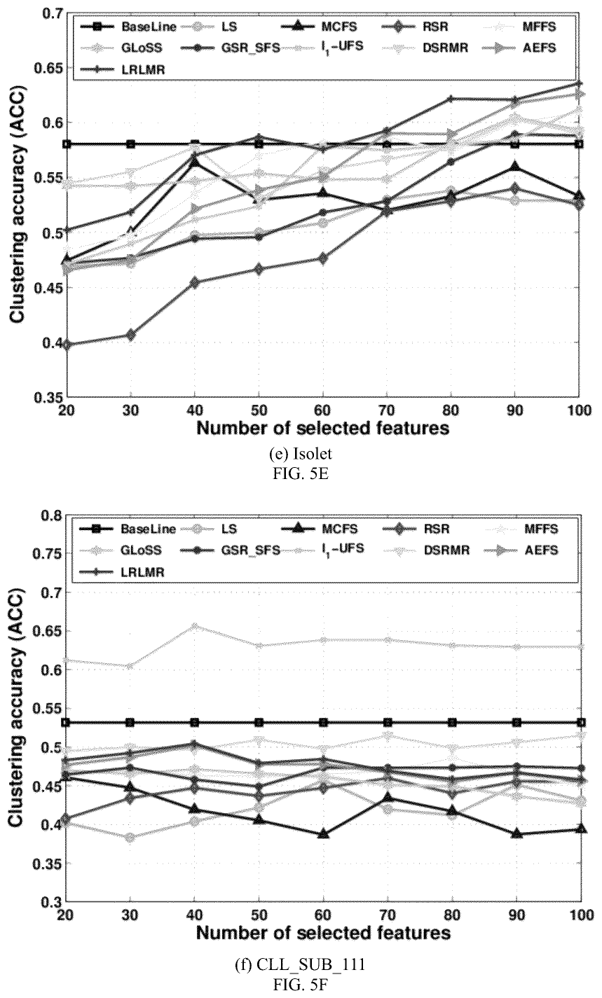

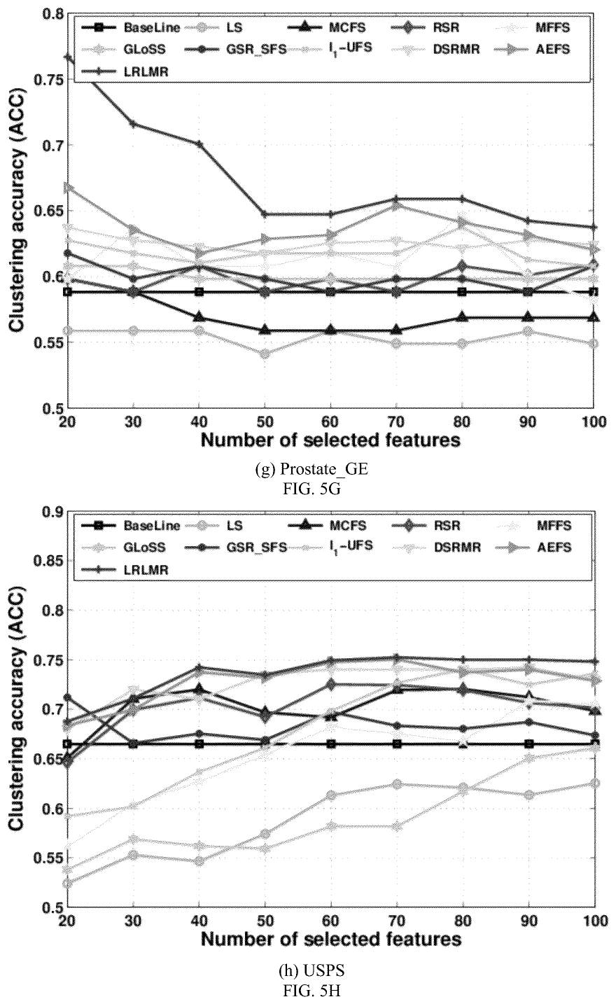

FIG. 3 and FIG. 4 show ACC and NMI values on eight databases for different methods. It is to be seen that the present application is better than other methods for ACC for three reasons: first, unlike previous methods of independently processing each data instance, the present method uses mutual connection information between data instances through potential latent space learning; second, the present method performs feature selection in the potential space rather than in an initial data space, which makes the present method more robust to noise features and data instances; and third, a graph-based manifold regularization constraint term may preserve the local geometry of the data well.

It is worth noting that the LRLMR method is clearly superior to other methods on the two biological microarray databases (CLL_SUB_111 and Prostate_GE) due to characteristics of biogenetic data collection. The biological microarray database is obtained by detecting different genes under different conditions, the number of the detected genes corresponds to a feature dimension, and each detection condition generates a data instance. In this case, different data instances are derived from the same gene per se, and therefore, the different data instances are necessarily dependent on each other. Since the potential latent space learning in the LRLMR method can directly exploit this link between microarray data instances, the present method is clearly superior to other methods on both databases.

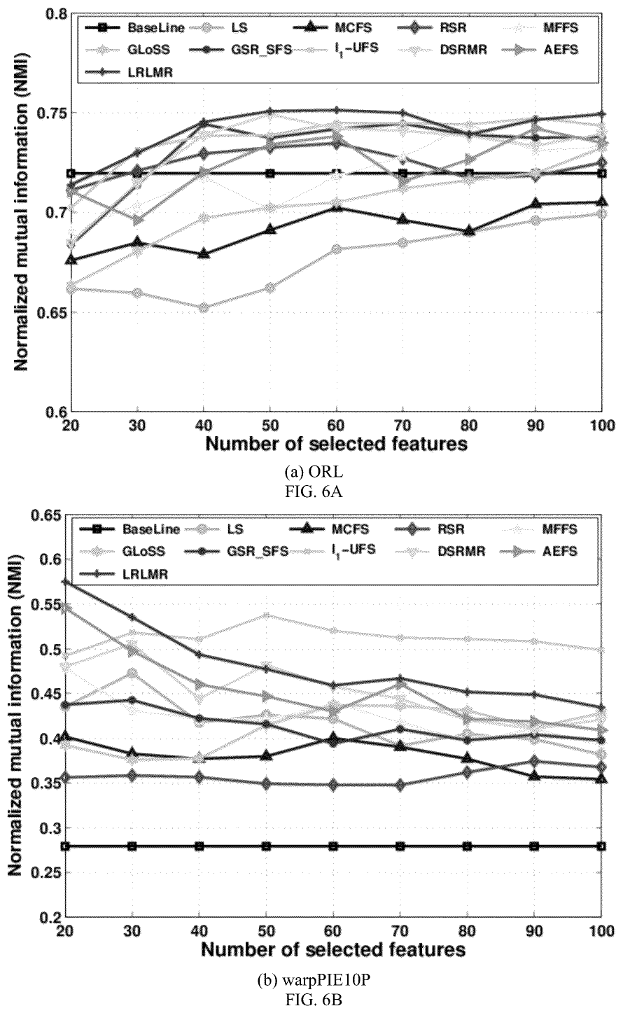

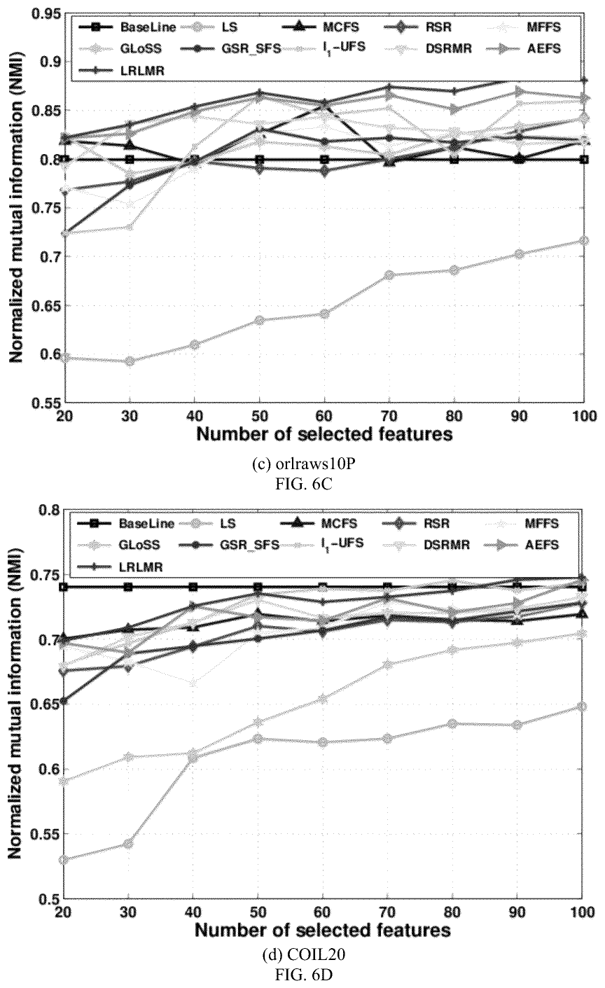

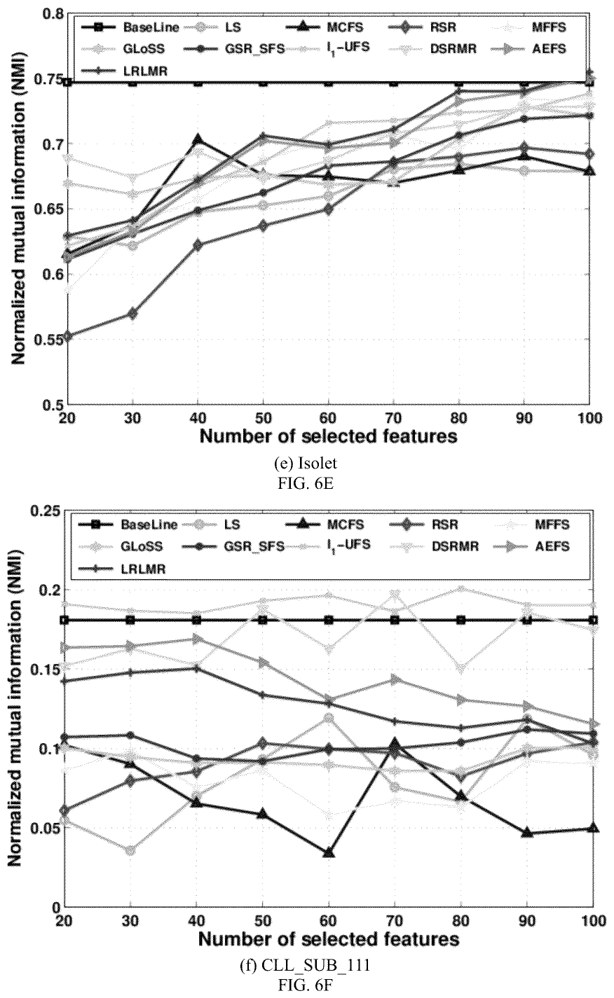

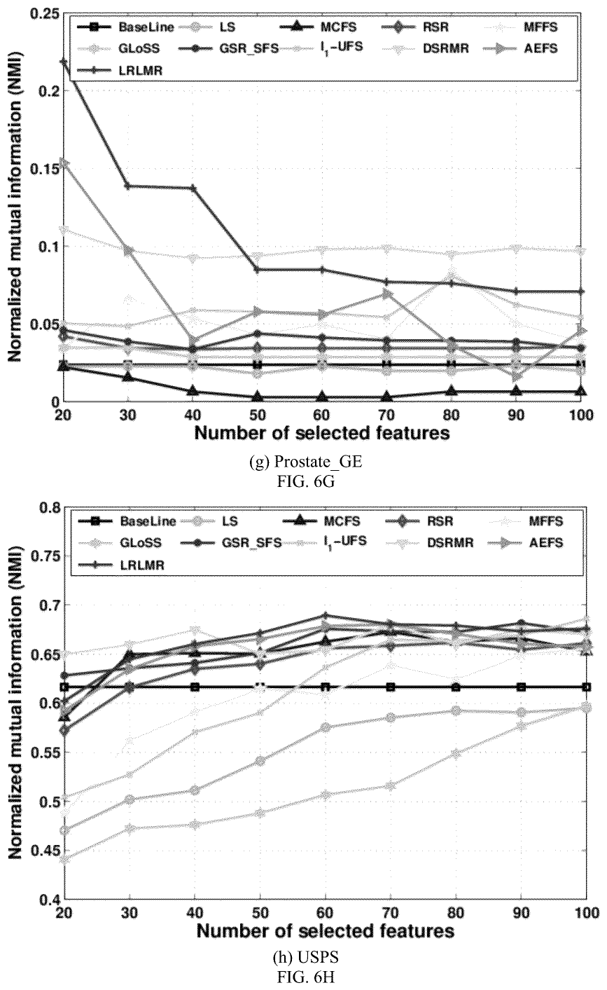

In order to verify impacts of feature selection on a clustering result, performance of all methods on different databases with different numbers of selected features is shown in FIGS. 55H and FIGS. 6A-6H. It is to be seen that the present method is always superior to other methods for different selected feature numbers. It is worth noting that the smaller the feature number is, the greater the ACC value of the LRLMR method is compared to the LS method, which proves that the present method can save clustering time and improve clustering accuracy better.

### Parameter Sensitivity:

Three equilibrium parameters (α, β and γ) are included in the present application, two of which are fixed and the remaining one is changed in order to investigate the sensitivity of the present application to the parameters.

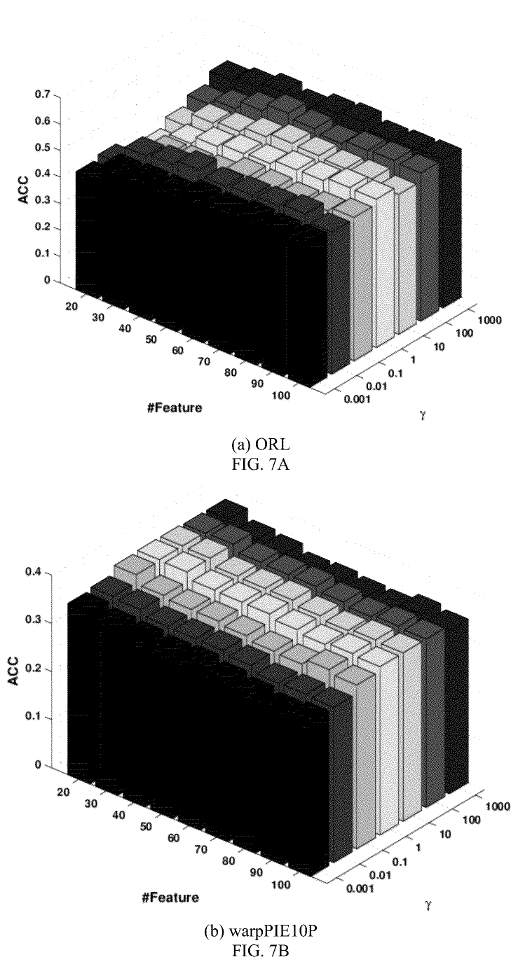

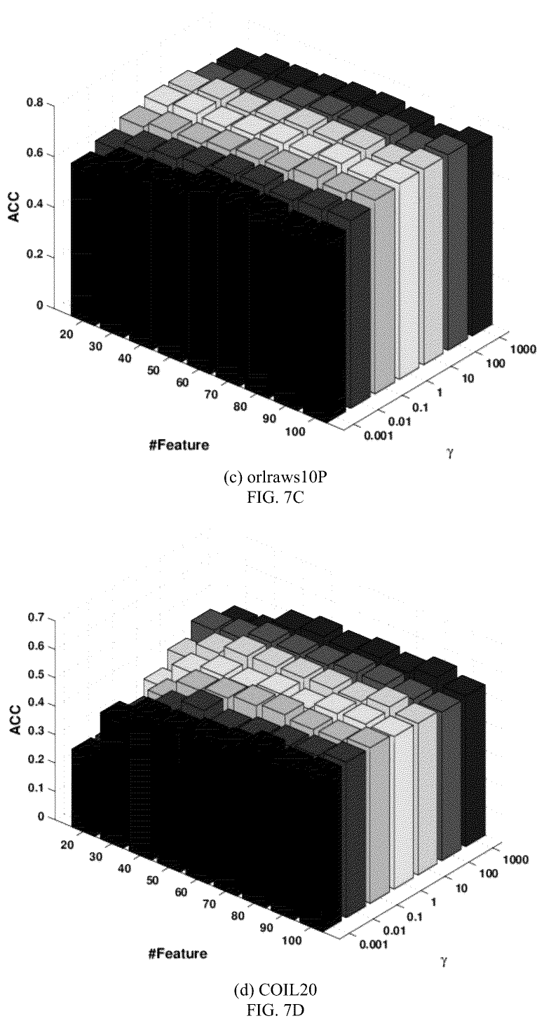

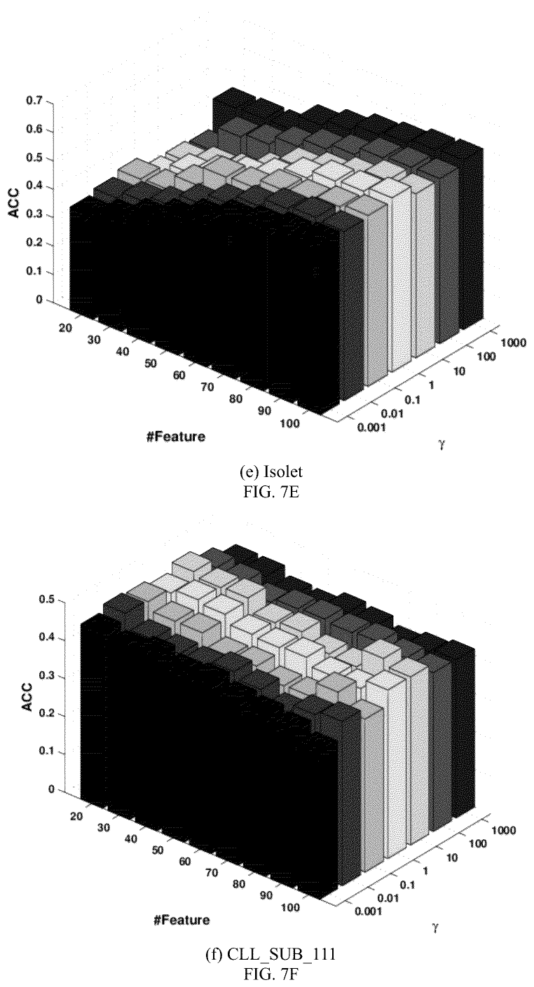

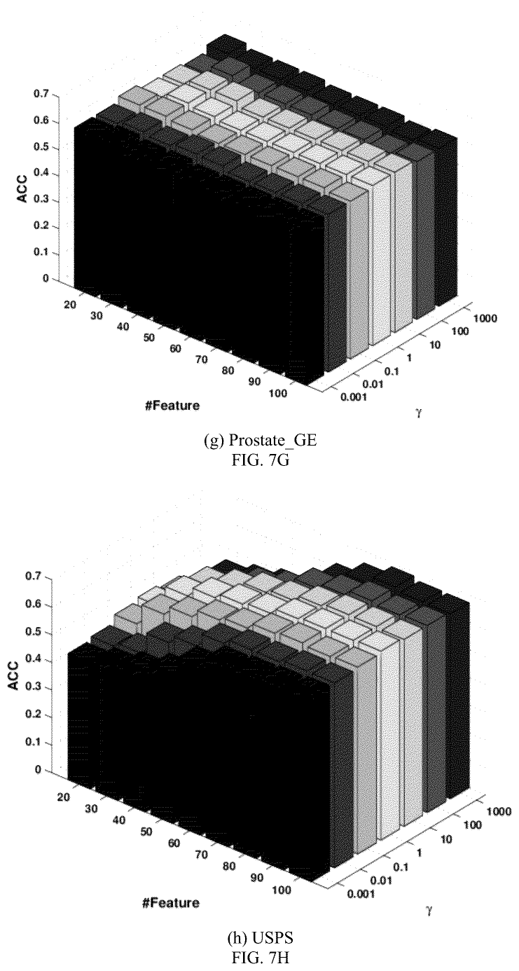

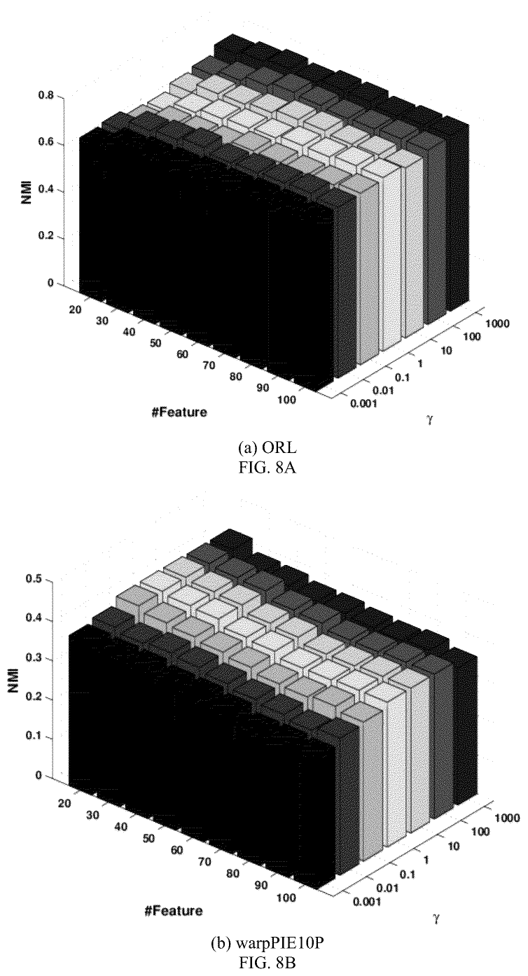

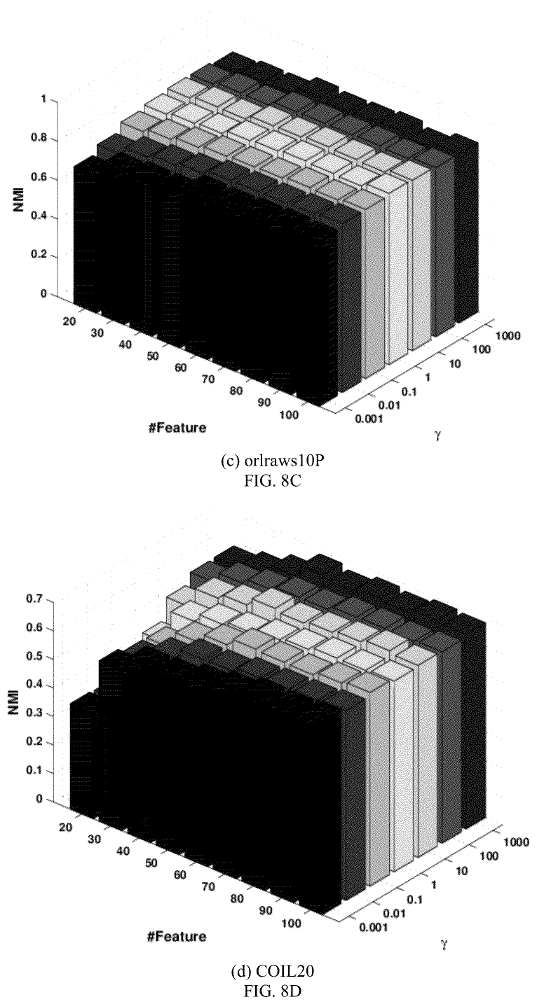

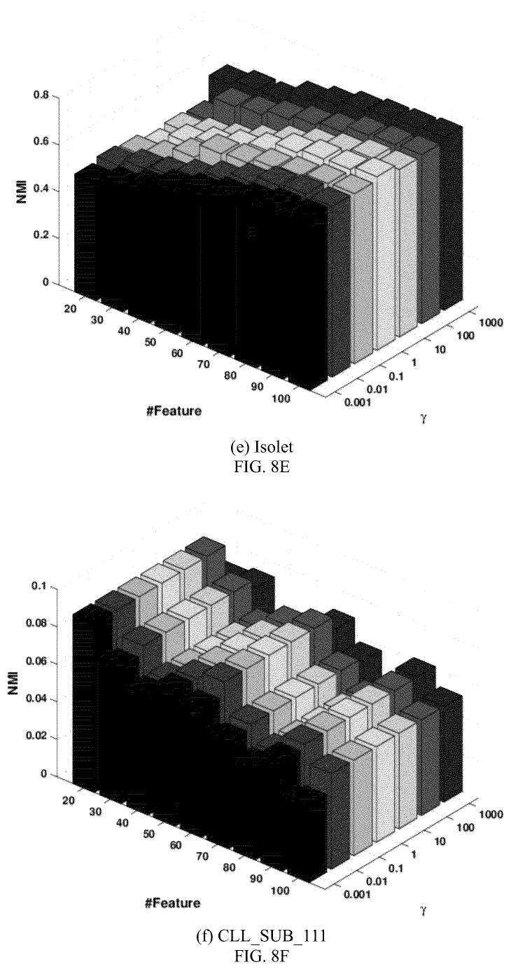

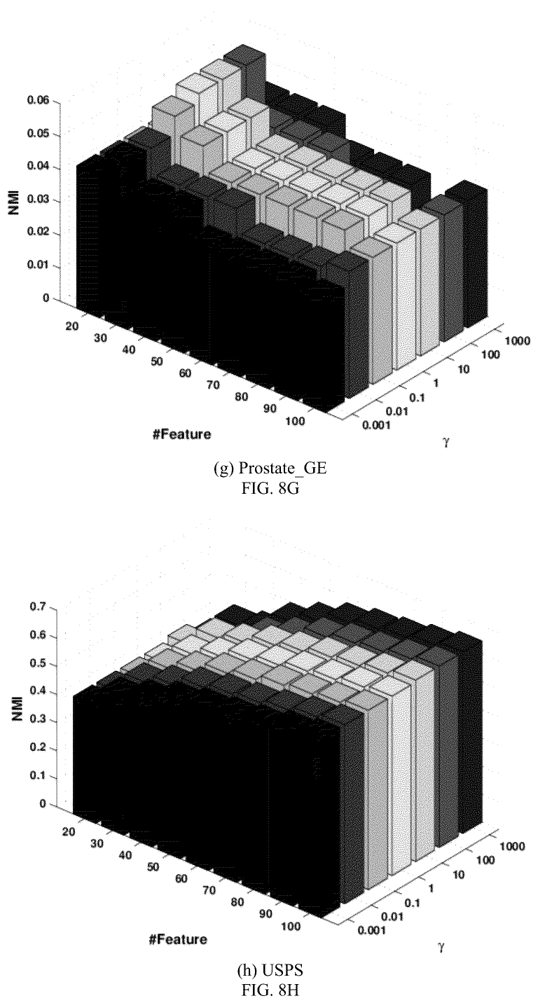

α=1, β=1 is fixed, a value of γ is changed, and ACC and NMI values on different databases are shown in FIGS. 7A-7H and FIGS. 8A-8H. It is to be seen that when the number of selected features is fixed, a result tends to be stable regardless of change of γ.

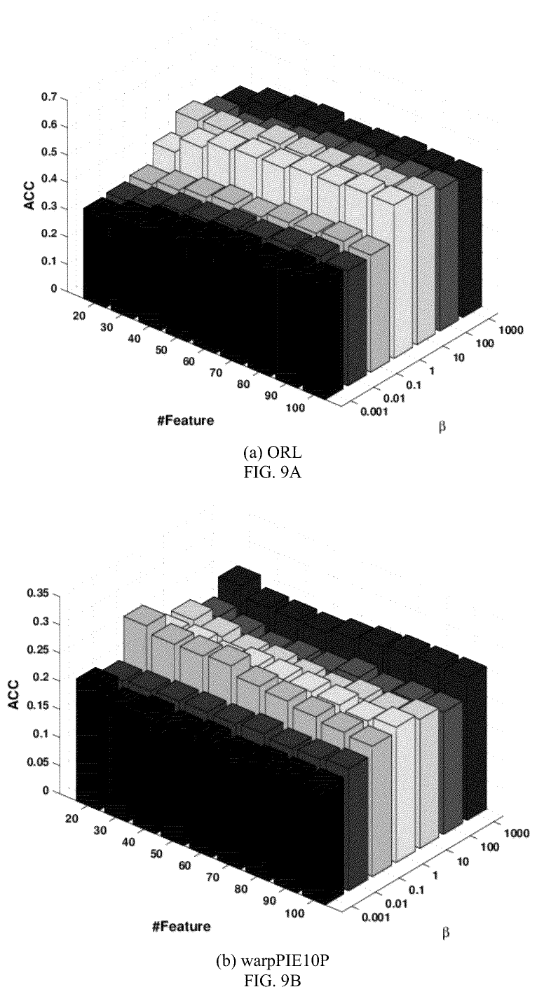

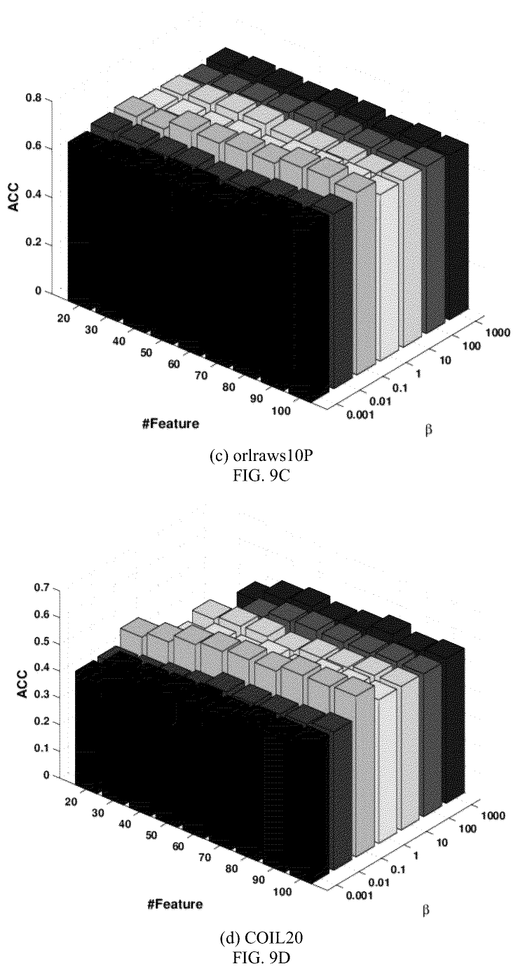

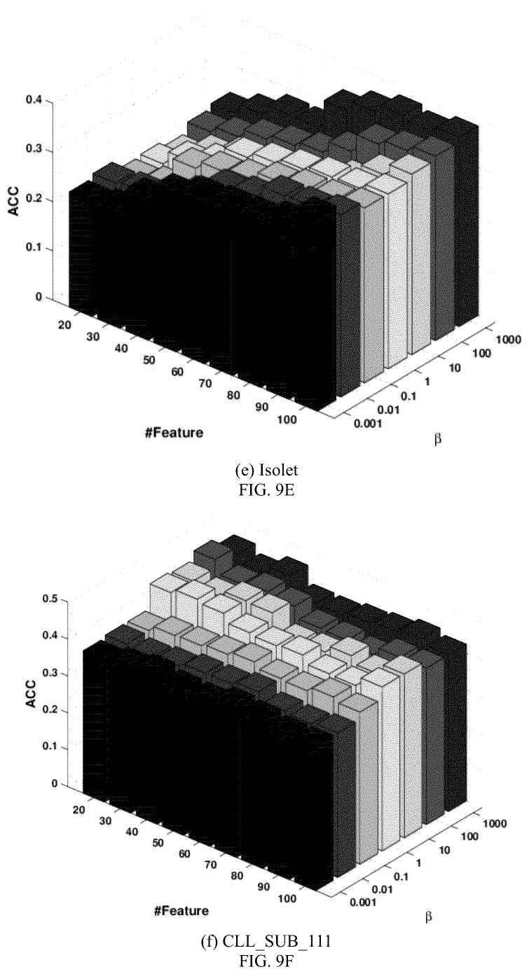

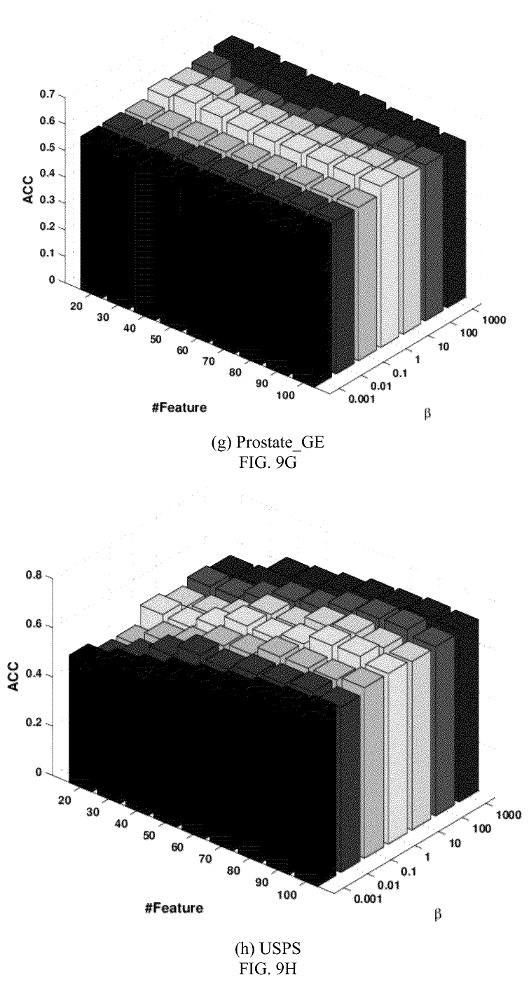

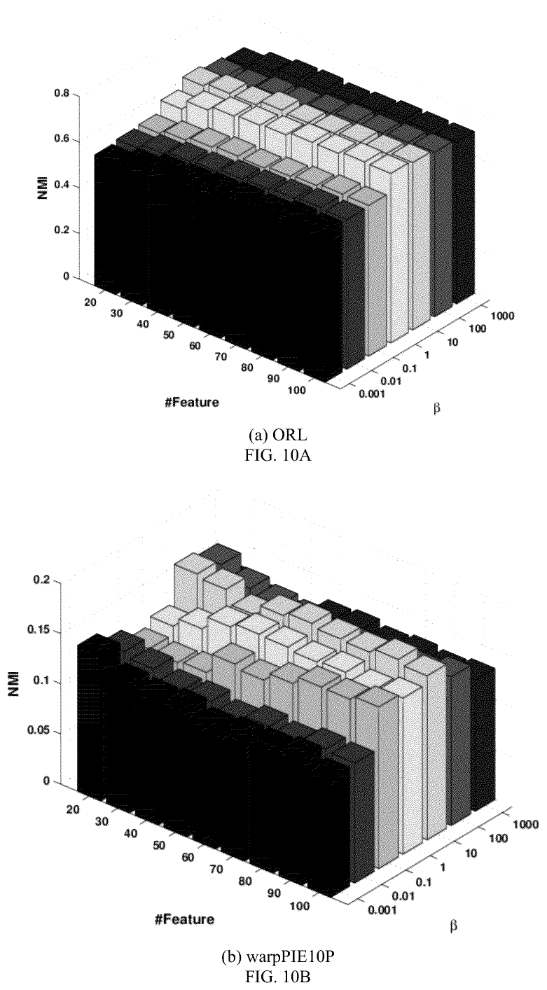

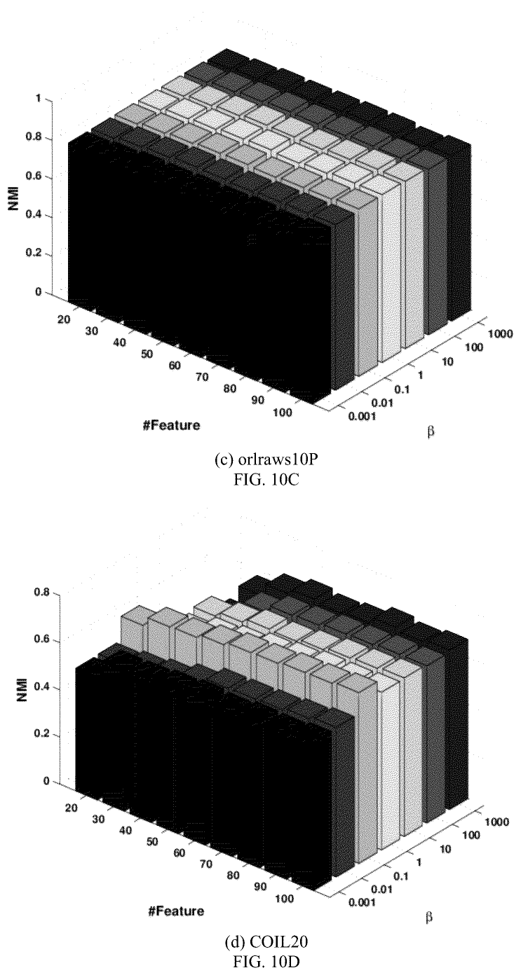

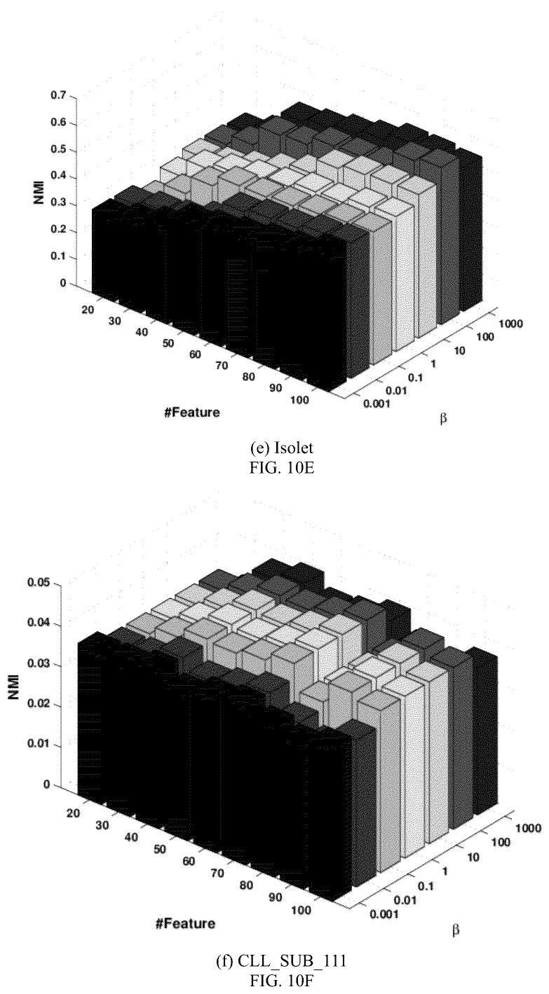

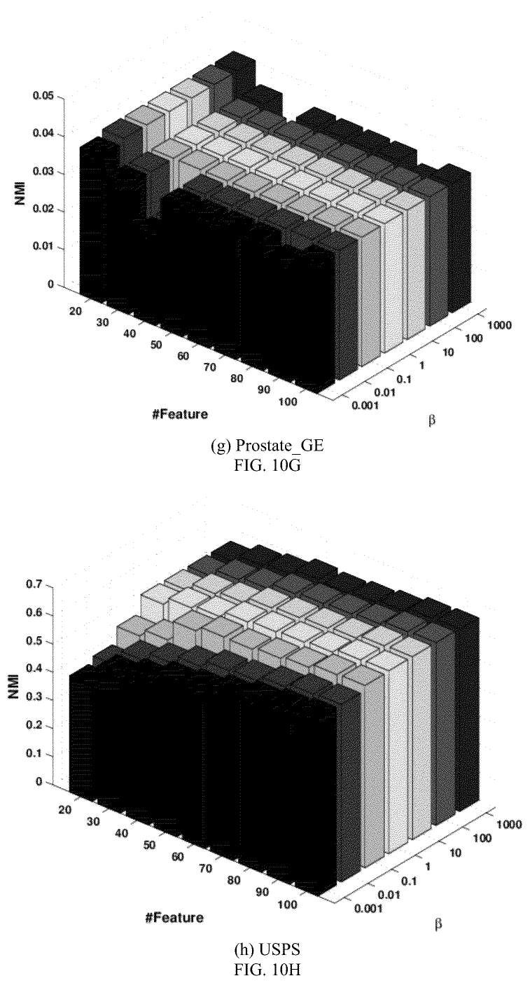

α=1, γ=1 is fixed, a value of β is changed, and ACC and NMI values on different databases are shown in FIGS. 9A-9H and FIGS. 10A-10H. It is to be seen that results are somewhat unstable on databases ORL, warpPIE10P and COIL20: for the database ORL, ACC and NMI values are relatively high when β>1; for the database warpPIE10P, a result is relatively good when 0.1<β<100; and for the database COIL20, the best result can be obtained when β=0.1 and results tend to be stable in other cases.

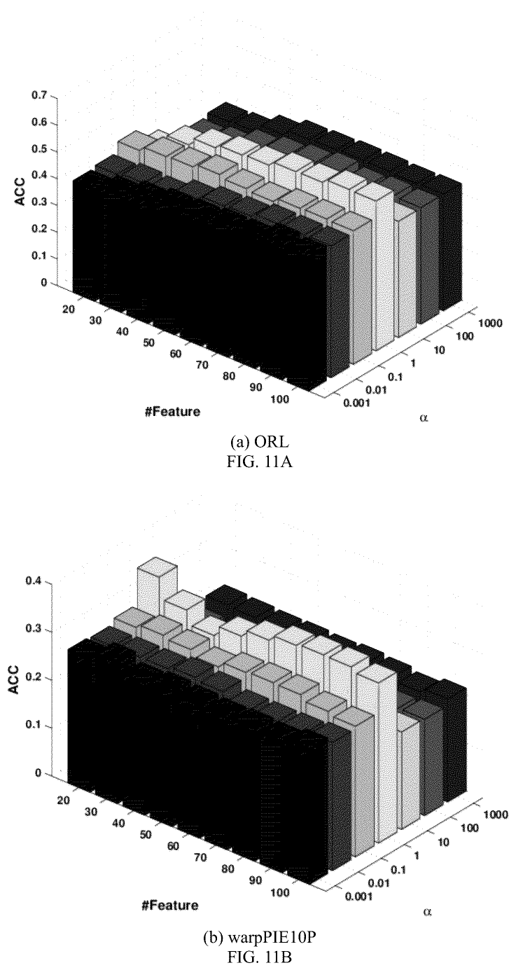

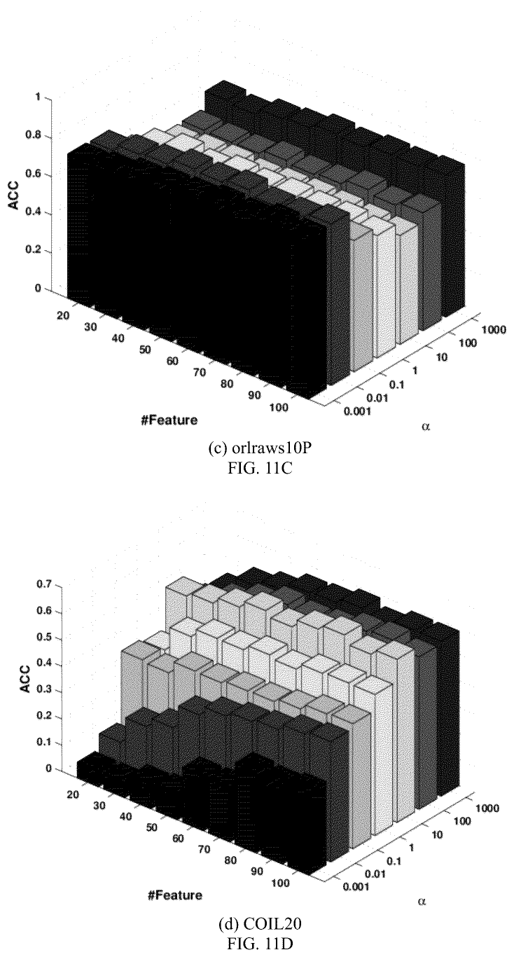

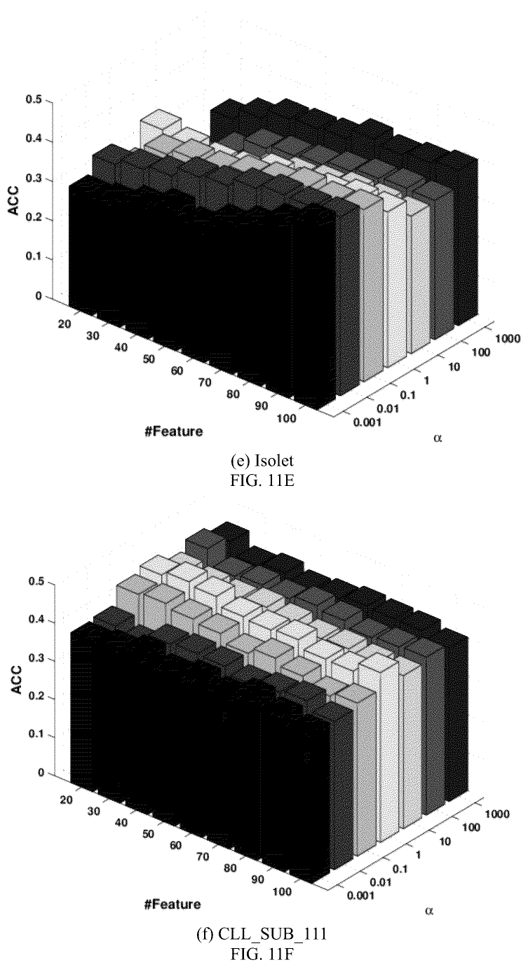

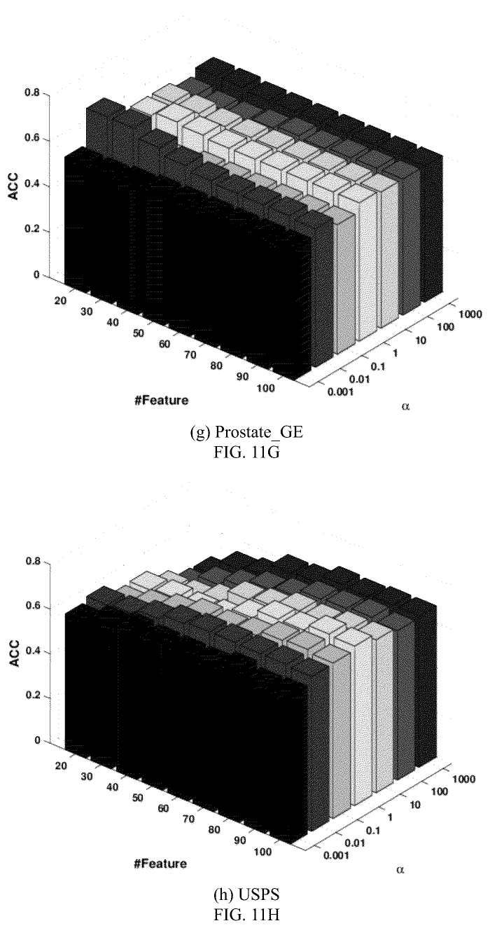

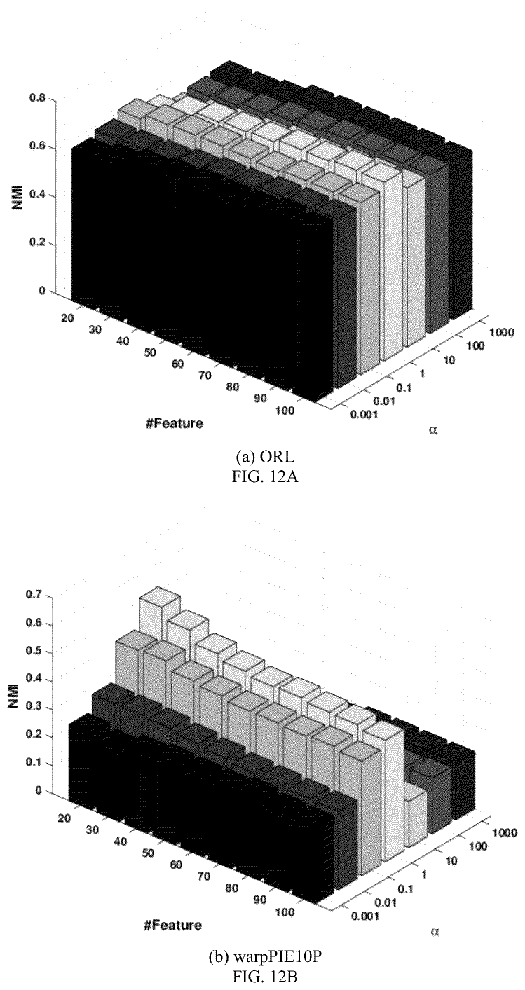

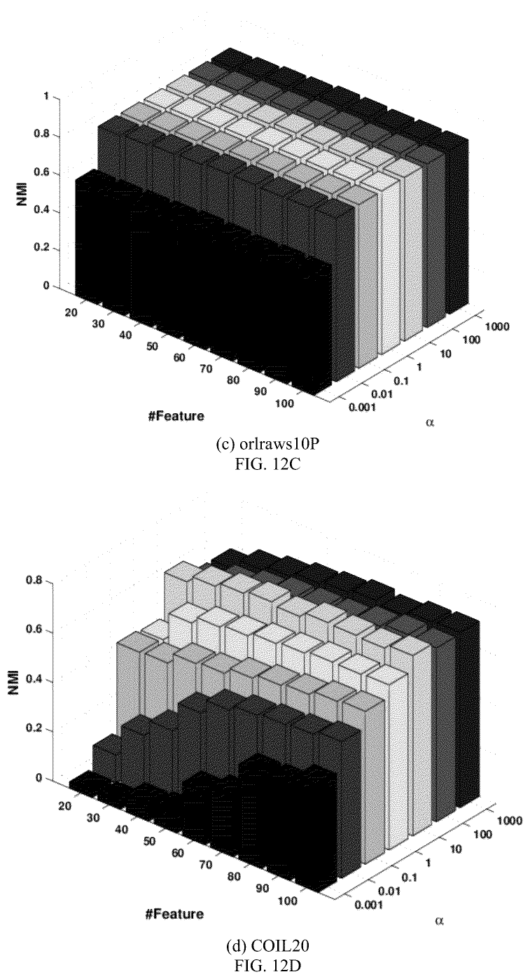

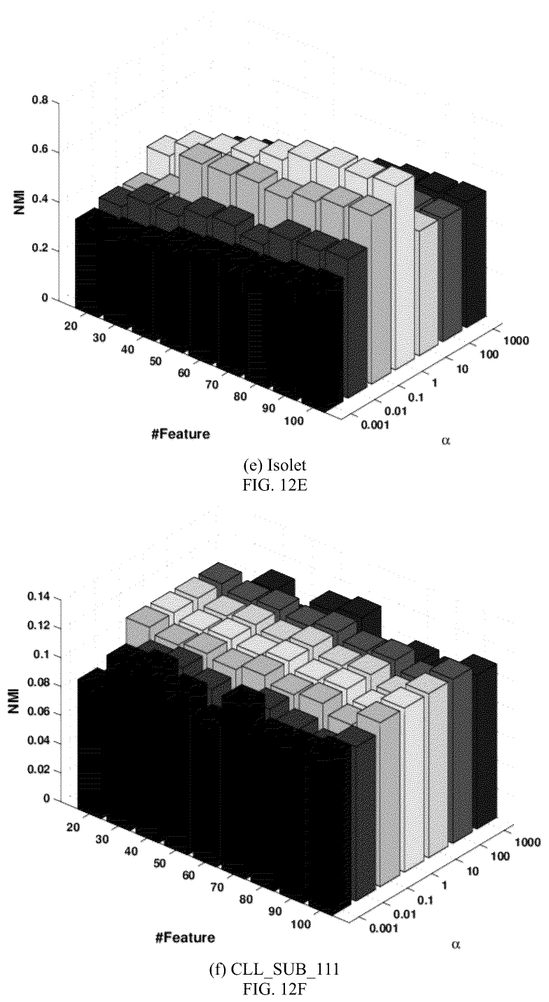

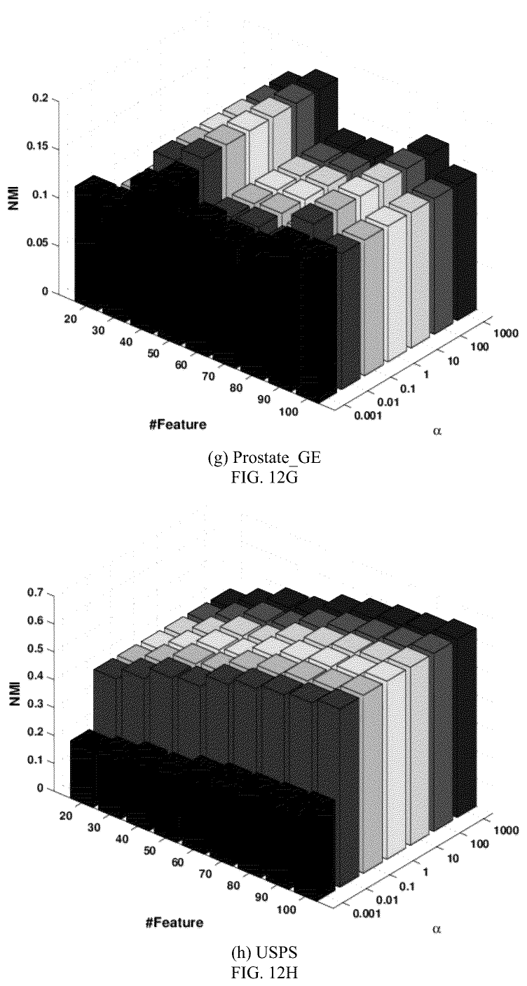

β=1, γ=1 is fixed, a value of α is changed, and ACC and NMI values on different databases are shown in FIGS. 11A-11H and FIGS. 12A-12H. It is to be seen that for the database warpPIE10P, a result rises abruptly to a peak when α=1; for the database COIL20, a result changes relatively fast and when 0.001<α<100, the greater a value of α is, the better a result is; and results tend to be stable in other cases.

### Calculation Time Analysis of the LRLMR Algorithm:

In a process of solving the objective function by an optimization algorithm, main time cost lies in two portions: solving W and solving V. For updating a W portion, main time cost depends on inverting a matrix (X^{T}X+αΛ+γX^{T}LX) and a time complexity of each iteration is o(d³); for solving a V portion, a time complexity can be neglected since only multiplication and division of elements are calculated, so the total time cost of algorithm I is t·t₁o(d³), t₁ is the number of iterations to update W, and t is the number of outer loop iterations of algorithm I.

### Convergence Analysis of the LRLMR Algorithm:

Convergence of the optimization algorithm proposed by the method is mainly analyzed, and it should be noted that:

$$\frac{\partial F ( \hat{W} )}{W} = {X}^{T} ( XW - V ) + αΛ W + γ {X}^{T} LXW$$

$$\frac{{\partial }^{2} F ( \hat{W} )}{{W}^{2}} = {X}^{T} X + αΛ + γ {X}^{T} LX$$

It is clear that the objective function F(W,V) with respect to W is a quadratic optimization problem, which means that its optimal value is obtained by

$$\frac{\partial F ( \hat{W} )}{W} = 0$$

and the result is:

\hat{W}=(X^{T}X+αΛ+γX^{T}LX)⁻¹X^{T}V

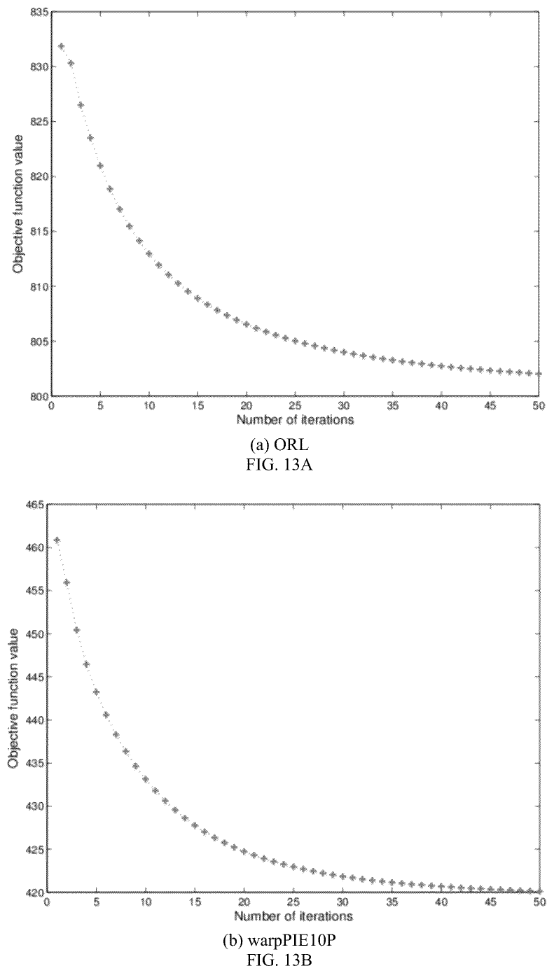

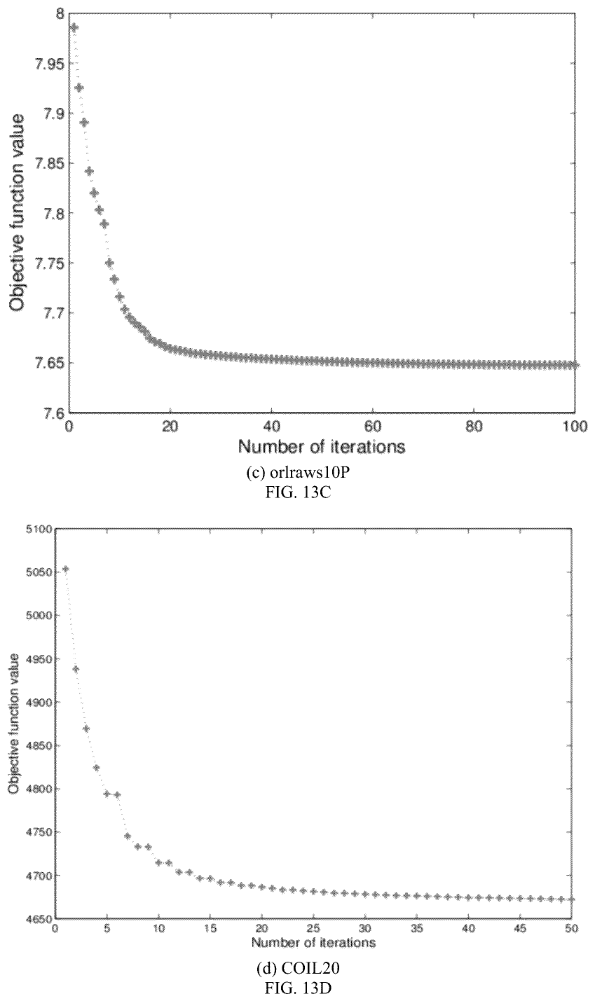

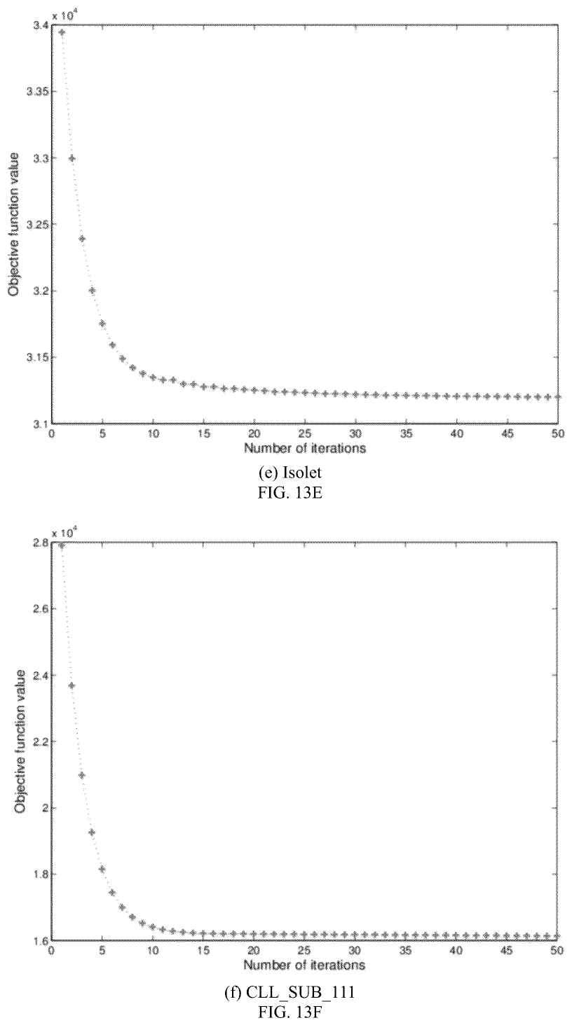

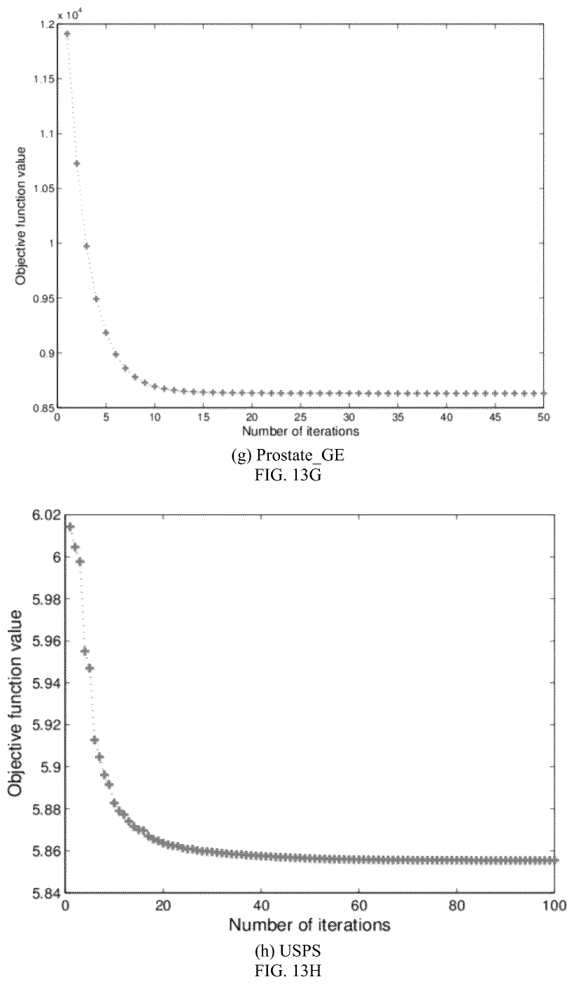

When W is fixed, F(V) is a quadratic function with an inequality constraint. According to Kuhn-Tucker conditions, values of the objective function decrease along with iterations, and an optimal solution of V can be obtained. Therefore, in conclusion, convergence of algorithm I is ensured. A convergence curve of algorithm I on different data sets (α=0.001, β=0.001, γ=0.001) is shown in FIGS. 13A-13H.

It should be noted that the above is only the preferred embodiments of the present application and the principles of the employed technologies. It should be understood by those skilled in the art that the present application is not limited to the particular embodiments described herein, and those skilled in the art can make various obvious changes, rearrangements, and substitutions without departing from the protection scope of the present application. Therefore, although the above embodiments have provided a detailed description of the present application, the application is not limited to the above embodiments, and may further include other equivalent embodiments without departing from the spirit of the present application, and the scope of the present application is determined by the scope of the appended claims.

What is claimed is:

1. An unsupervised feature selection method based on latent space learning and manifold constraints, comprising:
S1, inputting an original data matrix to obtain a feature selection model;
S2, embedding latent space learning into the feature selection model to obtain a feature selection model with the latent space learning;
S3, adding a graph Laplacian regularization term into the feature selection model with the latent space learning to obtain an objective function;
S4, solving the objective function by adopting an alternative iterative optimization strategy; and
S5, sequencing each feature in the original data matrix, and selecting first k features to obtain an optimal feature subset.

2. The unsupervised feature selection method based on the latent space learning and manifold constraints of claim 1, wherein, the feature selection model with the latent space learning obtained in step S2 is represented as:
$${min}_{W} {‖ XW - V ‖}_{F}^{2} + α {‖ W ‖}_{2 , 1} + β {‖ A - {VV}^{T} ‖}_{F}^{2} ,$$
$$s . t . V \geq 0$$
wherein, V∈R^{n×c} represents a latent space matrix of n data, and c represents a number of potential factors; X∈R^{n×d} represents the original data matrix, and d represents a data feature dimension; W∈R^{d×c} represents a transform coefficient matrix, and A represents an adjacency matrix; V^{T} represents a transposed matrix of V; F represents a Frobenius norm; α and β represent parameters for balancing latent space learning and potential space feature selection.

3. The unsupervised feature selection method based on the latent space learning and manifold constraints of claim 2, wherein step S2 comprises:
S21, decomposing the adjacency matrix A into a latent space matrix V and a transposed matrix V^{T} of the latent space matrix V through a symmetrical non-negative matrix decomposition model; wherein a product of V and V^{T} in a low dimensional potential space is represented as:
min∥A−VV^{T}∥_{F}²
S22, performing feature matrix transform on data in the latent space matrix V to obtain transformed data, and modeling the transformed data through a multiple linear regression model, represented as:
$${min}_{W} {‖ XW - V ‖}_{F}^{2} ,$$
wherein, W∈R^{d×c} represents a transform coefficient matrix;
S23, adding a l_{2,1} norm regularization term to the transform coefficient matrix W, represented as
$${min}_{W , V} {‖ XW - V ‖}_{F}^{2} + α {‖ W ‖}_{2 , 1} ,$$
and
S24, embedding the latent space learning into the feature selection model to obtain a feature selection model with the latent space learning.

4. The unsupervised feature selection method based on the latent space learning and manifold constraints of claim 2, wherein the objective function obtained in step S3 is represented as:
$$F ( W , V ) = {min}_{W , V} {‖ XW - V ‖}_{F}^{2} + α {‖ W ‖}_{2 , 1} + β {‖ A - {VV}^{T} ‖}_{F}^{2} + γ Tr ( {W}^{T} {X}^{T} LW ) ,$$
$$s . t . V \geq 0$$
wherein, γ represents an equilibrium local manifold geometry regularization coefficient; L represents a Laplacian matrix, L=D−S; D represents a diagonal matrix, Dᵢᵢ=Σⱼ₌₁ⁿSᵢⱼ, S represents a similarity matrix of similarity between pairs of measured data instances, represented as:
$${S}_{ij} = \{ \begin{matrix}exp ( \frac{{‖ {x}_{i} - {x}_{j} ‖}_{F}^{2}}{- 2 {σ}^{2}} ) , & {x}_{i} ∈ {N}_{k} ( {x}_{j} ) or {x}_{j} ∈ {N}_{k} ( {x}_{i} ) \\ 0 , & otherwise\end{matrix} ,$$
wherein, Nₖ(xᵢ) represents a set of xᵢ nearest neighbors; σ represents a width parameter; xᵢ∈R^{d} represents each row in the original data matrix X∈R^{n×d} sample; xⱼ represents each column in the original data matrix X∈R^{n×d} sample.

5. The unsupervised feature selection method based on the latent space learning and manifold constraints of claim 3, wherein step S4 comprises:
S41, initializing a latent space matrix V, V=rand(n,c), wherein, rand( )represents a random function, a number of iterations t=0, t₁=0, Λ^{t}^{₁}=I;
S42, fixing the latent space matrix V, and updating the transform coefficient matrix W, represented as:
\hat{W}=(X^{T}X+αΛ+γX^{T}LX)⁻¹X^{T}V
wherein, Λ∈R^{n×n} represents a diagonal matrix;
S43, setting the number of iterations to be t₁=t₁+1;
S44, fixing the transform coefficient matrix W, and updating the latent space matrix V, represented as:
$${V}_{ij} ← {V}_{ij} \frac{{( 2 XW + 4 β AV )}_{ij}}{{( 2 V + 4 β {VV}^{T} V )}_{ij}} ,$$
wherein, ← represents allocation; Vᵢⱼ represents an i^{th}I-row j^{th}-column element in the matrix V;
S45, setting the number of iterations to be t=t+1; and
S46, repeatedly executing steps S42-S45 until the objective function converges.

6. The unsupervised feature selection method based on the latent space learning and manifold constraints of claim 5, wherein, in step S42, the latent space matrix V is fixed, and the objective function is represented as:
$$F ( W ) = {min}_{W} {‖ XW - V ‖}_{F}^{2} + α {‖ W ‖}_{2 , 1} + γ Tr ( {W}^{T} {X}^{T} LXW ) ,$$
the diagonal matrix Λ is introduced into the objective function, and the diagonal matrix Λ is represented as:
$$Λ ( i , i ) = \frac{1}{2 {‖ W ( i , : ) ‖}_{2}} ,$$
wherein, ∥W(i,:)∥₂ represents the 2 norm of an i^{th} row vector, i.e. a feature quantity;
the objective function F(W) is translated into a weighted least squares problem, represented as:
$$F ( \hat{W} ) = {min}_{W} {‖ XW - V ‖}_{F}^{2} + α Tr ( {W}^{T} Λ W ) + γ Tr ( {W}^{T} {X}^{T} LXW ) ,$$
a derivative of F(Ŵ) with respect to w is calculated and a calculated derivative result is set to be 0, represented as:
X^{T}(XW−V)+αΛW+γX^{T}LXW=0.

7. The unsupervised feature selection method based on the latent space learning and manifold constraints of claim 5, wherein, in step S44, the transform coefficient matrix W is fixed, and the objective function is represented as:
$$F ( V ) = {min}_{V} {‖ XW - V ‖}_{F}^{2} + β {‖ A - {VV}^{T} ‖}_{F}^{2} , s . t . V \geq 0 ,$$
a Lagrange multiplier method is used for solving the objective function F(V), in order to limit V≥0, a Lagrange multiplier Θ∈R^{n×c} is set, and a Lagrange function is constructed and represented as:
$$F ( \hat{V} ) = {min}_{V} {‖ XW - V ‖}_{F}^{2} + β {‖ A - {VV}^{T} ‖}_{F}^{2} + Tr ( Θ {V}^{T} ) ,$$
a derivative of F(\hat{V}) with respect to V is calculated and a calculated derivative result is set to be 0, represented as:
−2XW+2V−4βAV+4βVV^{T}V+Θ=0.
